(19) United States
(12) Patent Application Publication
(10) Pub. No.: US 2025/0376151 A1
(43) Pub. Date: Dec. 11, 2025

(54) VEHICLE AND CONTROL METHOD FOR SAME

(71) Applicants: HYUNDAI MOTOR COMPANY, Seoul (KR); KIA CORPORATION, Seoul (KR)

(72) Inventors: Jin Kyeom Cho, Hwaseong-si (KR); Hyun Dong Her, Hwaseong-si (KR); Hyun Su Kim, Hwaseong-si (KR); Kyoung Soo We, Hwaseong-si (KR); Hong Bae Jeong, Hwaseong-si (KR); Dong Hyeon Woo, Hwaseong-si (KR); Hye Yeon Lee, Hwaseong-si (KR); Seok Cheon Jeon, Hwaseong-si (KR); Sun Woo Kim, Hwaseong-si (KR); Jung Mo Koo, Hwaseong-si (KR); Gyu Ri Lee, Hwaseong-si (KR)

(73) Assignees: HYUNDAI MOTOR COMPANY, Seoul (KR); KIA CORPORATION, Seoul (KR)

(21) Appl. No.: 18/945,259

(22) Filed: Nov. 12, 2024

(30) Foreign Application Priority Data
Jun. 11, 2024 (KR) 10-2024-0075375

(51) Int. Cl. B60W 30/02; B60W 10/18; B60W 30/09

(52) U.S. Cl. CPC B60W 30/02; B60W 10/18; B60W 30/09; B60W 2520/14; B60W 2554/802; B60W 2554/804; B60W 2710/18; B60W 2720/106; B60W 2720/14

(57) ABSTRACT

A method of controlling a vehicle includes detecting an object satisfying preset object conditions and driving conditions for approaching the vehicle. The method also includes determining a first control time according to the driving conditions and a second control time after the first control time. The method additionally include performing first vehicle stability control at the first control time. The method further includes performing second vehicle stability control in the opposite yaw-rate control direction to the first vehicle stability control at the second control time.

### CROSS-REFERENCE TO RELATED APPLICATION(S)

This application claims the benefit of and priority under 35 U.S.C. § 119 to Korean Patent Application No. 10-2024-0075375, filed on Jun. 11, 2024, in the Korean Intellectual Property Office, the entire contents of which are hereby incorporated herein by reference.

### BACKGROUND

### 1. Field of the Disclosure

The present disclosure relates to a vehicle and a control method therefor and, more specifically, to a vehicle capable of resolving vehicle instability caused by crosswinds generated while cars are driving past each other, and a control method therefor.

### 2. Description of the Related Art

Technologies are being developed to ensure stable vehicle driving by, when unstable vehicle behavior is detected, performing torque vectoring control to distribute braking force to each wheel or the like.

When a vehicle crosses another vehicle while driving, the crosswind may cause instability of vehicles. In particular, when a large vehicle crosses another vehicle driving in the opposite lane, the other vehicle may experience loud noise and vibration due to the crosswind caused by the large vehicle, resulting in longitudinal/lateral instability of the vehicle.

In addition, depending on weather conditions or road conditions, dust storms, snowstorms, etc., which are generated by the crosswind caused by the vehicle in the opposite lane after crossing, may obscure the driver's view.

Such instability and limited visibility may affect the driving safety of the vehicle and the user.

The foregoing described as this Background section is intended merely to aid in the understanding of the background of the present disclosure. Therefore, the Background section may include information that does form prior art that is already known to those having ordinary skill in the art to which the present disclosure pertains.

### SUMMARY

Embodiments of the present disclosure prevent a vehicle from experiencing lateral instability due to crosswinds caused by other vehicles.

Embodiments of the present disclosure prevent accidents caused by limited visibility of the driver of a travelling vehicle when other vehicles cross or overtake the vehicle, thereby securing stability.

The technical subjects pursued in the present disclosure are not limited to the above-mentioned technical subjects. Other technical subjects not mentioned herein should be more clearly understood by those having ordinary skill in the art to which the present disclosure pertains from the description below.

According to an embodiment, a method of controlling a vehicle is provided. The method includes detecting an object satisfying preset object conditions and driving conditions for approaching a vehicle. The method also includes determining a first control time according to the driving conditions and a second control time after the first control time. The method additionally includes performing first vehicle stability control at the first control time. The method further includes performing second vehicle stability control in the opposite yaw-rate control direction to the first vehicle stability control at the second control time.

According to an embodiment, the first control time may be determined to be a first time at which lateral crossing of the vehicle begins, and the second control time may be determined to be a second time at which the lateral crossing of the vehicle ends.

According to an embodiment, performing the first vehicle stability control may include performing lopsided braking control on a wheel of the vehicle, which is provided on a side facing the object in the lateral direction of the vehicle, at the first time.

According to an embodiment, performing the second vehicle stability control may include performing lopsided braking control on a wheel of the vehicle, which is provided on a side opposite the object in the lateral direction of the vehicle, at the second time.

According to an embodiment, performing the first vehicle stability control may include performing control to add compensation torque corresponding to lopsided braking torque of the first vehicle stability control to driving torque of the vehicle and output the same.

According to an embodiment, the method may further include controlling longitudinal acceleration of the vehicle in at least one of the first vehicle stability control and the second vehicle stability control.

According to an embodiment, the first vehicle stability control may include control to reduce longitudinal acceleration of the vehicle, and the second vehicle stability control may include control to increase longitudinal acceleration of the vehicle.

According to an embodiment, the longitudinal acceleration control may be performed through coasting torque control of the vehicle.

According to an embodiment, the driving conditions may be determined based on at least one of relative distance information between the object and the vehicle and image information of the object, and the object conditions may be determined based on at least one of size information of the object and relative speed information between the object and the vehicle.

According to an embodiment, performing the first vehicle stability control may include determining a yaw rate based on a preset model using at least one of object information including the size of the object, vehicle information including at least one of speed, longitudinal acceleration, and lateral acceleration of the vehicle, relative speed information between the object and the vehicle, and relative distance information therebetween.

According to another embodiment, a vehicle is provided. The vehicle includes a sensor unit configured to detect an object that satisfies preset object conditions and driving conditions for approaching the vehicle. The vehicle also includes a controller configured to determine a first control time according to the driving conditions and a second control time after the first control time. The controller is also configured to perform first vehicle stability control at the first control time. The controller is additionally configured to perform second vehicle stability control in the in opposite yaw-rate control direction to the first vehicle stability control at the second control time.

According to an embodiment, the first control time may be determined to be a first time at which lateral crossing of the vehicle begins, and the second control time may be determined to be a second time at which the lateral crossing of the vehicle ends.

According to an embodiment, the controller may be configured to perform lopsided braking control on a wheel of the vehicle, which is provided on a side facing the object in the lateral direction of the vehicle, at the first time, thereby performing the first vehicle stability control.

According to an embodiment, the controller may be configured to perform lopsided braking control on a wheel of the vehicle, which is provided on a side opposite the object in the lateral direction of the vehicle, at the second time.

According to an embodiment, the controller may be configured to perform control to add compensation torque corresponding to lopsided braking torque of the first vehicle stability control to driving torque of the vehicle and output the same.

According to an embodiment, the controller may be configured to control longitudinal acceleration of the vehicle in at least one of the first vehicle stability control and the second vehicle stability control.

According to an embodiment, the first vehicle stability control may include control to reduce longitudinal acceleration of the vehicle, and the second vehicle stability control may include control to increase longitudinal acceleration of the vehicle.

According to an embodiment, the controller may be configured to perform the longitudinal acceleration control through coasting torque control of the vehicle.

According to an embodiment, the driving conditions may be determined based on at least one of relative distance information between the object and the vehicle and image information of the object.

According to an embodiment, the controller may be configured to perform the first vehicle stability control based on a determined yaw rate, and the yaw rate may be determined based on a preset model using at least one of size information of the object, speed information of the vehicle, relative speed information between the object and the vehicle, and relative distance information therebetween.

According to an embodiment of the present disclosure, it is possible to prevent a vehicle from experiencing lateral instability due to crosswinds.

In addition, it is possible to prevent accidents caused by limited visibility of the driver of a travelling vehicle when other vehicles cross or overtake the vehicle, thereby securing stability.

The effects provided by the present disclosure are not limited to the above mentioned effects. Other effects not mentioned herein should be more clearly understood by those having ordinary skill in the art to which the present disclosure pertains from the description below.

### BRIEF DESCRIPTION OF THE DRAWINGS

The above and other aspects, features, and advantages

of the present disclosure should be more apparent from the following detailed description taken in conjunction with the accompanying drawings, in which:

FIG. 1 is a drawing illustrating the configuration of a controller according to an embodiment of the present disclosure.

FIG. 2 is a drawing illustrating the operation of a controller according to an embodiment of the present disclosure.

FIG. 3 is a drawing illustrating a situation in which a vehicle detects an object while driving according to an embodiment of the present disclosure.

FIG. 4 is a drawing illustrating a state in which a vehicle begins to pass an object at a first time according to an embodiment of the present disclosure.

FIG. 5 is a drawing illustrating a state in which a vehicle completes passing an object at a second time according to an embodiment of the present disclosure.

FIG. 6 is a graph showing an example of a yaw rate predicted by a controller based on a preset model according to an embodiment of the present disclosure.

FIG. 7 is a graph illustrating lopsided braking torque and motor compensation torque control of a controller according to an embodiment of the present disclosure.

FIG. 8 is a graph illustrating longitudinal acceleration control of a controller according to an embodiment of the present disclosure.

FIG. 9 is a flowchart in which a controller performs a vehicle stabilization operation in response to a crosswind caused by an object according to an embodiment of the present disclosure.

FIG. 10 is a flowchart illustrating first-section torque control from a pre-approach time to an approach start time by a controller according to an embodiment of the present disclosure.

FIG. 11 is a flowchart illustrating second-section torque control from an approach start time to a post-approach time by a controller according to an embodiment of the present disclosure.

FIG. 12 is a flowchart illustrating third-section torque control from a post-approach time to an approach end time by a controller according to an embodiment of the present disclosure.

FIG. 13 is a drawing illustrating a situation in which an object overtakes a vehicle according to an embodiment of the present disclosure.

### DETAILED DESCRIPTION

Hereinafter, embodiments of the present are described in detail with reference to the accompanying drawings. Same or similar elements are given the same or similar reference numerals even when the elements are illustrated in different drawings, and duplicate descriptions thereof have been omitted.

The terms “module” and “unit” used for the elements in the following description are given or interchangeably used in consideration of only the ease of writing the specification, and do not have distinct meanings or roles by themselves.

Furthermore, in describing the embodiments set forth herein, detailed descriptions of known relevant technologies have been omitted when it was determined that the description may obscure the gist of the present disclosure. In addition, it should be appreciated that the accompanying drawings are provided merely to enhance the understanding of the embodiments set forth herein, and the technical idea of the present disclosure is not limited to the accompanying drawings. The present disclosure includes all modifications, equivalents, or alternatives falling within the spirit and scope of the described embodiments of the present disclosure.

Terms including an ordinal number such as “a first” and “a second” may be used to describe various elements, but the elements are not limited to the terms. The above terms are used merely for the purpose of distinguishing one element from other elements.

In the case where an element is referred to as being “connected” or “coupled” to any other elements, it should be understood that not only the element may be directly connected or coupled to the other elements, but also another element may exist therebetween. Contrarily, in the case where an element is referred to as being “directly connected” or “directly coupled” to any other element, it should be understood that no other element exists therebetween.

A singular expression may include a plural expression unless they are definitely different in a context.

As used herein, expressions such as “include,” “comprise,” or “have” are intended to specify the existence of mentioned features, numbers, steps, operations, elements, components, or combinations thereof, and should be construed as not precluding the possible existence or addition of one or more other features, numbers, steps, operations, elements, components, or combinations thereof.

When a component, device, element, or the like of the present disclosure is described as having a purpose or performing an operation, function, or the like, the component, device, or element should be considered herein as being “configured to” meet that purpose or perform that operation or function.

A unit or a control unit included in names such as a motor control unit (MCU) is merely a term widely used for naming a controller configured to control a specific function of a vehicle, but does not mean a generic function unit. For example, in order to control a function that a control unit is responsible for, the control unit may include a communication device configured to communicate with a sensor or another control unit, a memory configured to store an operation system, or input/output a logic command, information, and at least one processor configured to perform determination, calculation, decision or the like which are required for responsible function controlling.

Although the present disclosure can be applied to any type of vehicle, such as a hybrid vehicle or an internal combustion engine vehicle, an electric vehicle to which an embodiment of the present disclosure is applied is described below by way of example for the convenience of explanation.

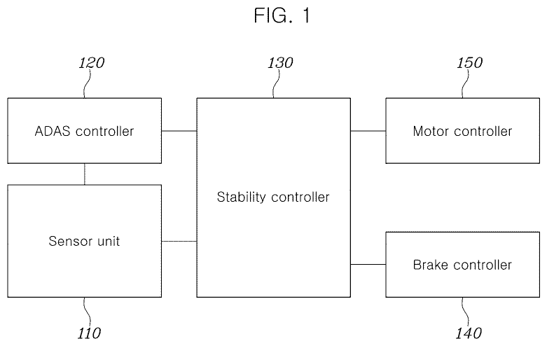

FIG. 1 is a drawing illustrating a configuration of a controller according to an embodiment of the present disclosure.

Referring to FIG. 1, a controller according to an embodiment of the present disclosure may include a sensor unit 110, an ADAS (Advanced Driver Assistance Systems) controller 120, a stability controller 130, a brake controller 140, and a motor controller 150.

The sensor unit 110 may include a camera, a radar, a lidar, a vehicle speed sensor, an acceleration sensor, a yaw rate sensor, or the like. Here, information of the camera and radar sensor may be transmitted to the ADAS controller 120, and information about the vehicle's speed, acceleration, and yaw rate may be transmitted to the stability controller 130.

The ADAS controller 120 may detect an object based on various sensor information transmitted from the sensor unit 110 and may determine the relative distance and relative speed with respect to the detected object.

Here, the object to be detected may indicate an object having a certain size or more. The object may be located in the lane adjacent to the driving lane of the vehicle and may move in a direction approaching the vehicle. In an example, the object may be a passenger car or a cargo vehicle that is driving faster than the vehicle from behind in the same direction as the vehicle or is approaching in the opposite lane (a lane beyond the center line).

The stability controller 130 may determine each control time described below based on the detected object information, relative distance information, and relative speed information. The stability controller 130 may transmit a control command to the brake controller 140 and the motor controller 150.

In an embodiment, although the stability controller 130 may be a separate controller performing a stabilization function in response to the crosswind according to the embodiment, this is an example and the present disclosure is not necessarily limited thereto. For example, the stability controller 130 may be implemented as a function of another controller, such as an ESC (Electronic Stability Control) controller or a vehicle control unit (VCU).

The brake controller 140 may control the hydraulic brake attached to each wheel based on the control command provided from the stability controller 130.

For example, the brake controller 140 may perform lopsided braking to control the hydraulic brake of one wheel according to the provided control command, or may operate hydraulic brakes to reduce the longitudinal acceleration of the vehicle.

The motor controller 150 may control the driving torque of a vehicle motor based on the provided control command.

In an embodiment, the motor controller 150 may control the driving motor torque of the vehicle, such as increasing or decreasing the coasting torque, based on the control command provided from the stability controller 130.

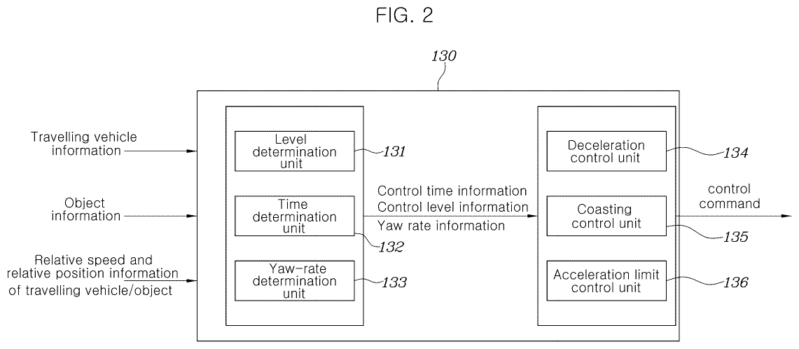

FIG. 2 is a drawing illustrating the operation of a controller according to an embodiment of the present disclosure.

Referring to FIG. 2, the stability controller 130 may output a control command to the brake controller 140 or the motor controller 150 based on driving vehicle information, object information, relative speed information of the driving vehicle and the object, and relative distance information thereof.

The stability controller 130 may include a level determination unit 131, a time determination unit 132, a yaw-rate determination unit 133, a deceleration control unit 134, a coasting control unit 135, and an acceleration limit control unit 136.

The level determination unit 131 may determine the control level using the size and relative speed of the detected object.

For example, the level determination unit 131 may determine the control level for the detected object by applying the size and relative speed of the object provided from the ADAS controller 120 to a preset level model.

The time determination unit 132 may determine the control time of the vehicle stabilization control to respond to the crosswind using the relative distance and speed information of the detected object.

For example, the control time may be divided into a pre-approach time at which the object is detected, an approach start time at which the object begins to cross the vehicle, a post-approach time at which the crossing of the object and the vehicle ends, and an approach end time after a predetermined time has passed from the post-approach time.

The yaw rate determination unit 133 may input provided information into a stored yaw-rate prediction model to predetermine the yaw rate value of the vehicle with time. In addition, the yaw rate determination unit 133 may provide the determined yaw rate to the deceleration control unit 134 and the coasting control unit 135, thereby providing a reference for the control torque according to the control time.

Here, the yaw-rate prediction model may be produced through repeated experiments in which data on changes in the yaw rate of the vehicle corresponding to the speed, relative speed, and relative distance of the driving vehicle is output.

The deceleration control unit 134, based on the provided control time, control level, and yaw rate information, may determine the braking torque and its magnitude of the hydraulic brake of each wheel corresponding to each time and transmit the same to the brake controller.

In addition, the coasting control unit 135, based on the provided control time, control level, and yaw rate information, may output a command to control the longitudinal acceleration of the vehicle through the motor or the hydraulic brake.

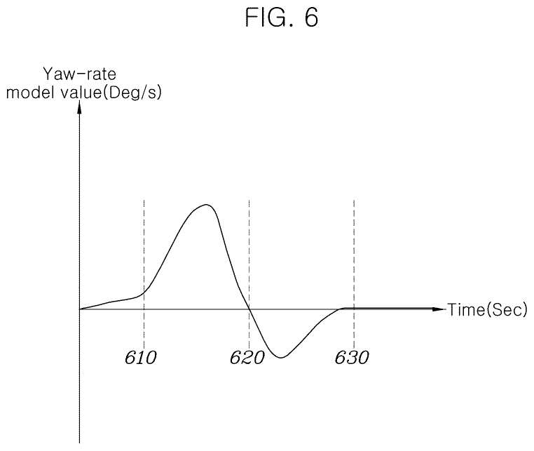

The acceleration limit control unit 136, based on the provided control time, control level, and yaw rate information, may output a command to limit the acceleration of the vehicle in a preset section. The specific operation of limiting the acceleration of the vehicle in the preset section, according to an embodiment, is described below with reference to FIG. 6.

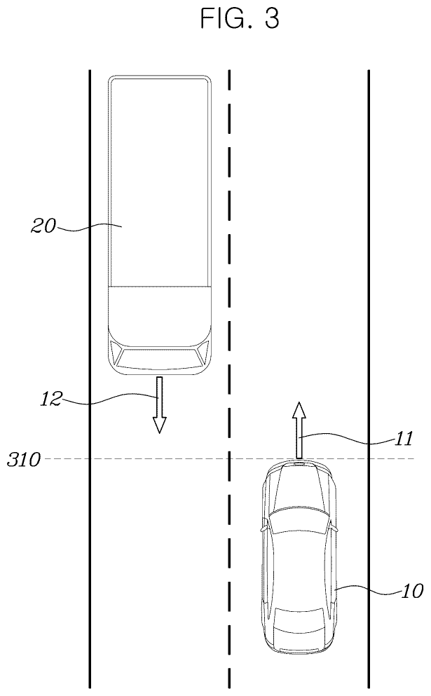

FIG. 3 is a drawing illustrating a situation in which a vehicle detects an object according to an embodiment of the present disclosure.

Referring to FIG. 3, a vehicle 10, to which the present disclosure is applied, is driving along a lane in a travelling direction (longitudinal direction) 11. An object 20 is driving in the left lane of the vehicle 10 in the opposite direction 12 of the vehicle's travelling direction 11.

For the convenience of the following explanation, the travelling direction of the vehicle 10 is defined as “forward direction”, the direction to the left of the vehicle is defined as “left direction”, the direction to the right of vehicle is defined as “right direction”, and the direction opposite the forward direction is defined as “backward direction”.

In addition, apart from vehicle 10, in the case of an object 20, the travelling direction of the object that is the same as the travelling direction of the vehicle is defined as a parallel direction, and the opposite direction thereof is defined as an opposite direction.

When an object 20 traveling in the opposite direction 21 is detected by the sensor unit 110 of the vehicle 10, the sensor unit 110 may obtain information about the object 20, and the stability controller 130 of the vehicle 10 may determine the control time, control level, and yaw rate of the vehicle 10 based on the obtained information.

For example, the object 20 may be detected based on image or photo information received from the camera of the vehicle 10 and radar information. The stability controller 130 of the vehicle 10 may obtain information about the size of the object 20 detected through the sensor unit 110, information about the relative distance to the vehicle 10, and relative speed information thereof.

However, the method of detecting the object 20 and the method of obtaining information therefrom are illustrative. The method may be performed using at least one of detection means such as a camera, a radar device, and a lidar device that are attached to the vehicle 10 to detect the object 20 and determine relative speed, relative distance, size information of the object 20, or a combination thereof.

In addition, the stability controller 130 may determine the control time according to preset conditions.

For example, the stability controller 130 may determine the pre-approach time, the approach start time, the post-approach time, and the approach end time by referring to the yaw-rate change time of the vehicle 10 determined based on the passing start time and passing end time with respect to the object 20.

Hereinafter, the control process of the vehicle 10 is described assuming that the stability controller 130 determines the control time based on the four times described above.

In an embodiment, after the object 20 is detected, the stability controller 130 may determine the time at which the yaw rate begins to change due to the crosswind to the vehicle 10 caused by the approach of the object 20 as the pre-approach time.

In addition, after the pre-approach time, the stability controller 130 may determine the time at which the vehicle 10 and the object 20 begin to cross each other when viewed in the lateral direction as the approach start time.

In addition, the stability controller 130 may determine the time at which the vehicle 10 and the object 20 complete crossing in a view in the lateral direction as the post-approach time, and may determine the time at which the change in yaw-rate determined after the post-approach time ends as the approach end time.

In an embodiment, the stability controller 130 may predetermine the control time, based on a stored lookup table or the like, using the relative speed information and relative distance information between the vehicle 10 and the object 20.

However, the method of determining each time described above is illustrative. In some embodiments, the time may be determined as a value obtained by adding a certain margin to the preset relative distance or may be determined using other variables in addition to the relative distance.

In addition, the stability controller 130 may determine a control level based on the relative speed and size information of the object 10 and determine the yaw rate of the vehicle 10.

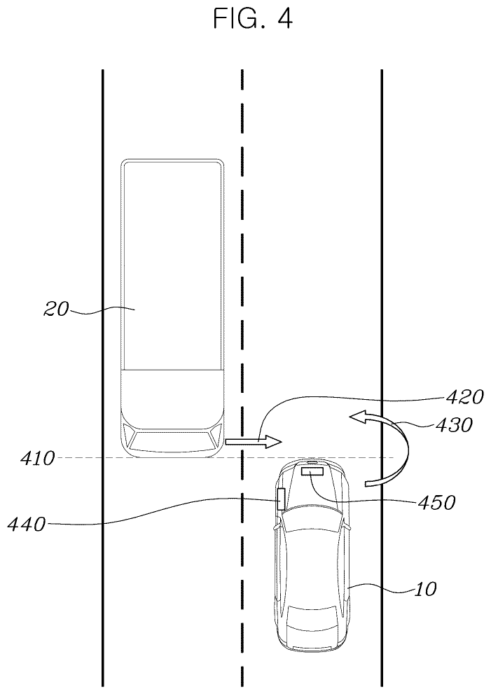

FIG. 4 is a drawing illustrating a state in which a vehicle begins to pass an object at the approach start time according to an embodiment of the present disclosure.

FIG. 4 shows the state in which the object 20 is driving in the opposite direction of the vehicle 10 on the left side of the vehicle 10 at an approach start time position 410.

At the approach start time position 410, the crossing of the vehicle 10 and the object 20 may cause a crosswind (hereinafter, a left crosswind) 420 against the side of the vehicle 10 from the left to the right. In this case, the left crosswind 420 may cause a change 430 in the yaw rate of the vehicle 10 to the right direction relative to the travelling direction.

Here, the stability controller 130 may control the vehicle 10 to perform first vehicle stability control at the approach start time based on the control level and yaw-rate change determined at the pre-approach time.

In an embodiment, the first vehicle stability control may include deceleration control and longitudinal acceleration control for the lateral stability of the vehicle 10.

For example, when the driver wishes to reduce the speed (e.g., stepping on the brakes), the stability controller 130 may perform deceleration control to output a lopsided braking control command for the left front wheel 440. In an embodiment, the magnitude of the lopsided braking torque may be controlled based on the determined control level and yaw rate. In addition, the lopsided braking of the left front wheel is intended to generate the left yaw to offset the right yaw of the vehicle 10 generated by the crosswind.

In addition, the stability controller 130 may prevent lateral drift of the vehicle 10 by improving the gripping force of the front wheels of the vehicle 10 through longitudinal acceleration control of the vehicle 10 at the approach start time.

For example, the stability controller 130 may increase the coasting torque (-) of the driving motor of the vehicle 10 at the approach start time, thereby reducing the longitudinal acceleration of the vehicle, so that the center of gravity moves forward to apply a greater load to the front wheels, thereby improving the front-wheel gripping force.

Here, in addition to controlling the coasting torque of the motor, the stability controller 130 may also reduce the longitudinal acceleration of the vehicle 10 through deceleration control to improve the gripping force of both front wheels of the vehicle 10.

In an embodiment, the magnitude of the coasting torque and deceleration control torque described above may be controlled based on the determined control level and yaw rate.

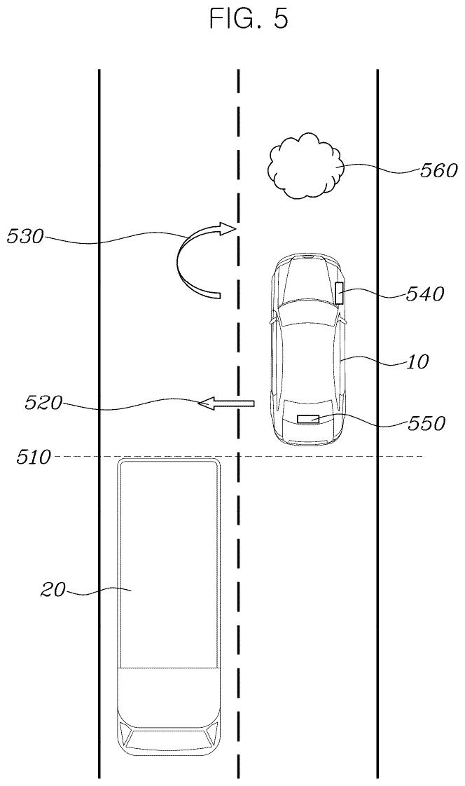

FIG. 5 is a drawing illustrating a state in which a vehicle completes passing an object at a post-approach time according to an embodiment of the present disclosure.

FIG. 5 shows a position 510 of the vehicle at the post-approach time at which the passing ends, and the relative position between the vehicle 10 and the object 20 that are traveling in the opposite directions corresponds to the sum of the total length of the vehicle 10 and the total length of the object 20.

At the position 510 of the vehicle at the post-approach time, a crosswind (hereinafter, a right crosswind) 520 caused by the crossing of the vehicle 10 and the object 20 may act on the vehicle 10 from the right to the left. In this case, the right crosswind 420 may cause a change in yaw rate of the vehicle 10 in the plus (+) direction 530.

In addition, if there is a snowdrift on the road, the forward view of the driver of the vehicle 10 may be obstructed by a snowstorm 560 caused by the crossing of the object 20 at the post-approach time 510. As another example, the case in which the driver's view of the vehicle 10 is obscured may include dust storms or the like depending on the conditions of the driving road.

Here, the stability controller 130 may control the vehicle 10 to start second vehicle stability control from the post-approach time based on the determined control level and yaw rate change. In an embodiment, a second stability control start time may correspond to a value obtained by adding or subtracting a preset margin to or from the determined post-approach time position 510.

In an embodiment, the second vehicle stability control may include lopsided braking control for the lateral stability of the vehicle 10 and longitudinal acceleration control.

For example, the stability controller 130 may perform a lopsided braking control for outputting, to the brake controller 140, a deceleration control command to increase the lopsided braking torque of the hydraulic brake of the right front wheel 560 of the vehicle in response to the right crosswind acting on the vehicle 10 at the post-approach time 510.

Similar to the first vehicle stability control, the lopsided braking operation may be configured to be performed when a deceleration command is obtained from the stability controller 130. The magnitude of the lopsided braking torque may be set based on the determined control level and yaw rate.

In addition, the stability controller 130 may improve the gripping force of both rear 550 wheels of the vehicle 10 through the longitudinal acceleration control of the vehicle 10 from the post-approach time.

For example, the stability controller 130 may increase the magnitude of the plus-direction coasting torque of the driving motor of the vehicle 10 at the post-approach time position 510, thereby increasing the longitudinal acceleration of the vehicle, so that the center of gravity may move rearwards, applying a greater load to the rear wheels to improve the rear-wheel gripping force.

Here, in addition to the control of the coasting torque of the motor, the stability controller 130 may also accelerate the longitudinal acceleration of the vehicle 10 through deceleration control to improve the gripping force of the rear wheels 560 of the vehicle 10.

Similar to the first vehicle stability control, the magnitudes of the aforementioned coasting torque and acceleration control torque may be controlled based on the determined control level and yaw rate.

In addition, even at the approach end time after a predetermined period of time has passed since the post-approach time so that the lateral stability control of the vehicle 10 is not necessary in response to the crosswind, the driver's view of the vehicle 10 may be obstructed by the snowstorm 560 or the like.

Here, the stability controller 130 may be controlled to limit the increase in acceleration torque of the vehicle 10 for a preset acceleration limit time for safety. At this time, the preset acceleration limit time may be set differentially depending on the level determined by considering the size, relative speed, etc. of the object 20.

FIG. 6 is a graph showing an example of a yaw rate predicted by a controller based on a preset model according to an embodiment of the present disclosure.

Referring to FIG. 6, the horizontal axis of the graph represents time, and the vertical axis represents the yaw rate depending on time. Here, the horizontal axis of the graph may show an approach start time 610, a post-approach time 620, and an approach end time 630 in sequence from the zero point to the right.

The stability controller 130 may predetermine a yaw rate of the vehicle 10 depending on time based on a prestored yaw rate model. For example, the relative speed and relative distance between the vehicle 10 and the object 20, the size of the object 20, and the speed information of the vehicle 10 may be input into the prestored yaw rate model, thereby predetermining the yaw rate depending on time before reaching each time.

In an example, the yaw rate of the vehicle 10 may slowly increase in the plus (+) direction due to the right sway of vehicle 10 from the time at which the change in yaw rate of the vehicle 10 due to the object 20 is detected to the approach start time 610.

In addition, it can be seen that, during the approach start time 610 to the post-approach time 620, the yaw rate rapidly increases in the plus (+) direction due to the crosswind as the vehicle 10 and the object 20 cross each other, and then decrease.

It can be seen that, during the post-approach time 620 to the approach end time 630, the yaw rate increases in the minus (−) direction due to the crosswind after the vehicle 10 and the object 20 cross each other, and then decrease as the object 20 gradually moves away.

Therefore, the stability controller 130 may output a torque control command corresponding to the control unit 140 and the motor control unit 150 according to each control time based on the yaw rate according to the determined time.

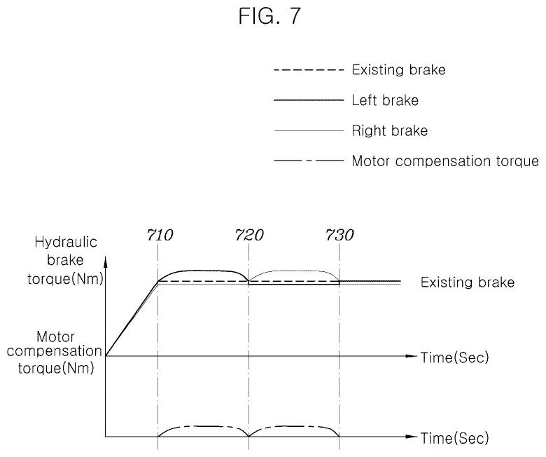

FIG. 7 is a graph illustrating lopsided braking torque and motor compensation torque control of a controller according to an embodiment of the present disclosure.

Referring to FIG. 7, the upper graph may represent hydraulic brake torque on the vertical axis depending on time on the horizontal axis, and the lower graph may represent motor compensation torque on the vertical axis depending on time on the horizontal axis.

The existing brake control operation in the upper graph may be performed such that, when a deceleration command is received, the hydraulic brake torque is increased to the same target braking torque in all brakes.

On the other hand, in the upper graph, the lopsided braking torque control to separately control the left and right brake torque may be further performed in addition to the existing braking operation, thereby preventing the vehicle 10 from drifting due to the crosswind.

In an embodiment, from the pre-approach time to the approach start time 710, the stability controller 130 may perform a deceleration control operation to cause the brake controller 140 to increase the hydraulic brake torque to the target braking torque.

In addition, in order to prevent excessive deceleration due to this lopsided braking operation, the stability controller 130 may control the motor to output compensation torque equivalent to the lopsided braking torque.

In an embodiment, from the approach start time 710 to the post-approach time 720, a first vehicle stability control may perform a lopsided braking operation to increase the torque of the left brake. In an embodiment, the magnitude of the lopsided braking torque may be controlled based on the determined control level and yaw rate change.

Here, the stability controller 130 may control the motor to output compensation torque corresponding to the lopsided braking torque to prevent a decrease in acceleration due to the lopsided braking.

In addition, from the post-approach time 720 to the approach end time 730, the stability controller 130 may perform a lopsided braking operation to increase the braking torque of the right brake.

Likewise, the stability controller 130 may control the motor to output compensation torque corresponding to the lopsided braking torque to prevent a decrease in acceleration due to the lopsided braking.

Here, the aforementioned deceleration control operation and the compensation torque output operation of the motor may be performed only when a deceleration command is transmitted from a brake pedal sensor or the like, which indicates that the user wishes to reduce the speed.

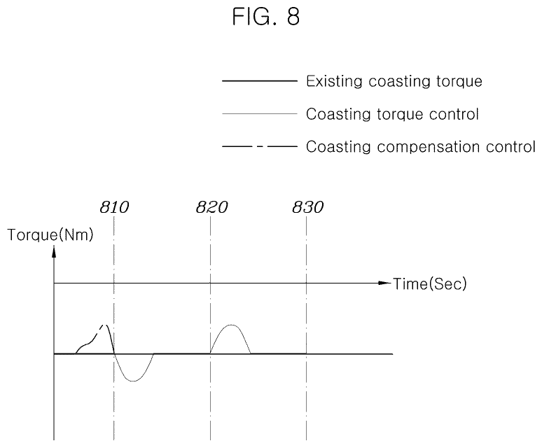

FIG. 8 is a graph illustrating longitudinal acceleration control of a controller according to an embodiment of the present disclosure.

Referring to FIG. 8, the graph shows a change in coasting torque on the vertical axis depending on time on the horizontal axis, based on each time.

In the existing coasting torque, control to output a constant torque may be performed.

On the other hand, in the case of the coasting torque according to an embodiment of the present disclosure, the coasting torque control for pitch control may be further performed in addition to the existing coasting torque control, thereby preventing the vehicle from drifting due to the crosswind.

In an embodiment, from the pre-approach time to the approaching start time 810, the stability controller 130 may perform control to increase the coasting torque in the plus (+) direction, thereby compensating for the coasting torque control to be performed thereafter.

Here, the stability controller 130 may determine the compensation torque corresponding to the coasting torque control to be performed in the second and third sections and may perform control to output the corresponding compensation torque in advance.

In addition, in the second section from the approaching start time 810 to the post-approach time 820, the stability controller 130 may perform control to increase the minus-direction coasting torque, thereby generating the forward pitch acceleration of the vehicle 10, and improve the gripping force of the both front wheels to prevent right drift.

In addition, in the third section from the post-approach time 820 to the approach end time 830, the stability controller 130 may perform control to increase the plus-direction coasting torque, thereby generating the rearward pitch acceleration of the vehicle 10, and improve the gripping force of the both rear wheels to prevent left drift.

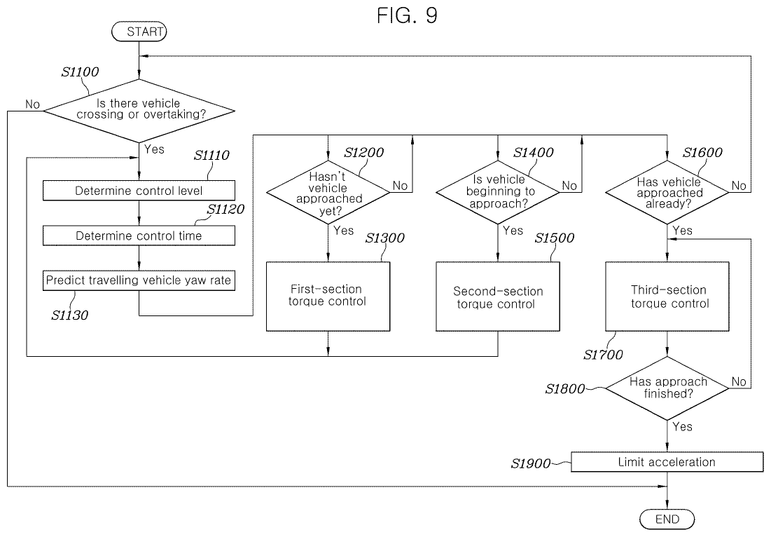

FIG. 9 is a flowchart in which a controller performs a vehicle stabilization operation in response to the crosswind caused by an object according to an embodiment of the present disclosure.

In an operation S1100, the stability controller 130 may determine whether there is a crossing or overtaking vehicle based on information received from the sensor unit 110.

In an embodiment, the stability controller 130 may detect an object 20 in the left or right lane based on information provided from the sensor unit 110 and predetermine whether the object 20 is to overtake or cross the vehicle 10.

Here, the stability controller 130 may receive image information, relative speed information, and relative distance information of the object 20 from the sensor unit 110.

However, this operation may be performed such that the ADAS controller 120 receives information from the sensor unit 110 and performs the detection operation of the object 20 and such that the stability controller 130 receives information from the sensor unit 110 and the ADAS controller 120 and determines whether the object 20 is to cross or overtake.

If there is a crossing or overtaking vehicle (“Yes” in the operation S1100), the stability controller 130 may determine a control level in an operation S1110.

Here, the control level may be determined according to a preset model based on the size and relative speed information of the object 20.

In an operation S1120, the stability controller 130 may determine a control time.

Here, the stability controller 130 may determine the pre-approach time, the approach start time, the post-approach time, and the approach end time based on the information provided.

In an embodiment, the stability controller 130, based on the relative speed information and the relative distance information with respect to the object 20, may determine each time by predetermining the time at which the relative distance between the vehicle 10 and the object 20 reaches a preset control criterion.

In an operation S1130, the stability controller may determine a yaw rate of the vehicle 10.

Here, the yaw rate of the vehicle 10 may be determined by applying the size information, relative distance, and relative speed information of the object 10 to a preset yaw rate model.

In an embodiment, the stability controller 130 may perform the determination by directly applying the size and relative speed information of the object 10 to the yaw rate model, or applying the control level determined based on the size and relative speed information of the object 10 to the yaw rate model.

In addition, the stability controller 130 may determine whether control times of the pre-approach time, the approach start time, and the post-approach time have been reached.

In an embodiment, in the case of the pre-approach time (“Yes” in an operation S1200), the stability controller 130 may perform torque control in the first section from the pre-approach time to the approach start time in an operation S1300.

Here, the pre-approach time may correspond to the time after detecting the object 20 and before the approach start time. For example, the stability controller 130 may determine the time at which a change in yaw rate is expected to start as the pre-approach time based on the aforementioned yaw rate model.

In addition, if the torque control in the first section ends, the stability controller 130 may reperform the control level determination operation S1110, the control time determination operation S1120, and the yaw-rate determination operation S1130 of the vehicle 10 to redetermine the control level, control time, and yaw rate by reflecting the information up to the first-section torque control end time.

In the case of the approach start time (“Yes” in an operation S1400, the stability controller 130 may perform the torque control in the second section from the approach start time to the post-approach time in an operation S1500.

Similarly, if the torque control in the second section ends, the stability controller 130 may reperform the control level determination operation S1110, the control time determination operation S1120, and the yaw-rate determination operation S1130 of the vehicle 10 to redetermine the control level, control time, and yaw rate by reflecting the information up to the second-section torque control end time.

In the case of the post-approach time at which the lateral crossing between the vehicle 10 and the object 20 ends (“Yes” in an operation S1600), the stability controller 130 may perform the torque control in the third section from the post-approach time to the approach end time in an operation S1700.

Here, the stability controller 130 may determine the time at which a change in yaw rate in the opposite direction of the second section is expected to start based on the aforementioned yaw rate model as the post-approach time.

In addition, the stability controller 130 may determine the time at which the yaw rate change due to the crosswind ends after the time at which the crossing between the vehicle 10 and the object 20 ends as the approach end time.

If the third-section torque control S1700 ends, the stability controller 130 may control the vehicle 10 to perform an acceleration limit operation S1900.

Specifically, even after the yaw rate change of the vehicle 10 due to the crossing of the object 20 ends, the driver's view of the vehicle 10 may be obstructed by the dust storm or the like.

Therefore, the stability controller 130 may perform control such that the acceleration of the vehicle 10 is restricted for a preset acceleration limit time from the approach end time.

Here, the preset acceleration limit time may be determined differently based on the size of the object 20 and the relative speed with respect to the vehicle 10.

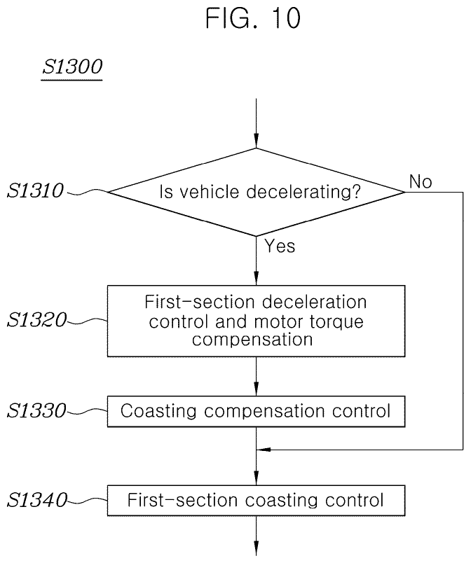

FIG. 10 is a flowchart illustrating first-section torque control (operation S1300) from the pre-approach time to the approach start time by a controller according to an embodiment of the present disclosure.

In the case of the pre-approach time (“Yes” in the operation S1200), stability the controller 130 may selectively perform first-section deceleration control in an operation S1320 depending on whether or not the vehicle 10 is decelerating as determined in an operation S1310.

In an embodiment, if a deceleration command is received (“Yes” in the operation S1310), the stability controller 130 may perform first-section deceleration control and an operation of compensating for the motor torque according thereto in an operation S1320.

Here, whether or not the vehicle is decelerating may be determined by a deceleration command or the like, that is detected from a brake pedal or the like and transmitted to the stability controller 130.

For example, the stability controller 130 may perform control such that the wheel of the vehicle 10 that is provided on the side facing the object 20 in the lateral direction of the vehicle 10 is braked from the pre-approach time to the approach start time.

In an operation S1330, the stability controller 130 may perform coasting compensation control.

For example, from the pre-approach time to the approach start time, the stability controller 130 may perform control to compensate for the motor coasting torque in consideration of the coasting operation to be performed at the approach start time and the post-approach time.

In an operation S1340, the stability controller 130 may perform the coasting control in the first section, regardless of whether or not deceleration occurs.

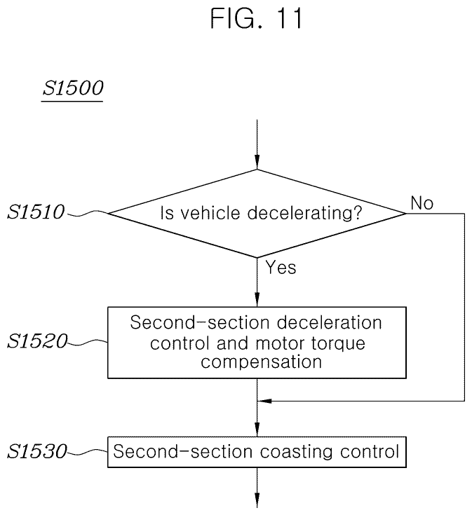

FIG. 11 is a flowchart illustrating second-section torque control (operation S1500) from the approach start time to the post-approach time by a controller according to an embodiment of the present disclosure.

In the case of the approach start time (“Yes” in the operation S1400), the stability controller 130 may selectively perform deceleration control depending on whether or not deceleration occurs in an operation S1510.

If a deceleration command is obtained (“Yes” in the operation S1510), the stability controller 130 may perform the deceleration control and motor torque compensation control in an operation S1520 in the second section, and the stability controller 130 may perform second-section coasting control, regardless of whether or not the deceleration command is obtained in an operation S1530.

Here, the deceleration control and motor torque compensation control in the second section are similar to those described in FIGS. 4, 7, and 8, so a detailed description thereof has been omitted.

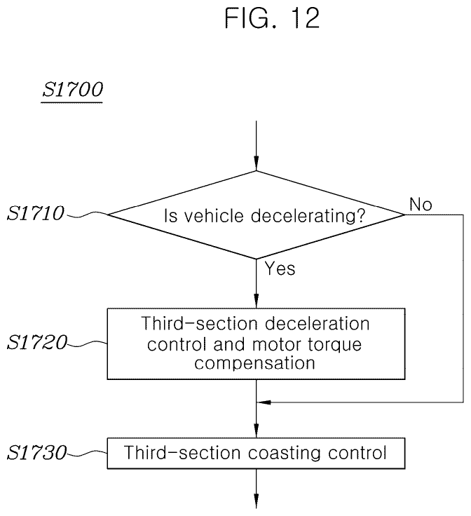

FIG. 12 is a flowchart illustrating the third-section torque control (operation S1700) from the approach start time to the post-approach time by a controller according to an embodiment of the present disclosure.

In the case of the approach start time (“Yes” in the operation S1600), the stability controller 130 may selectively perform third-section deceleration control depending on whether or not deceleration occurs in an operation S1710.

Specifically, if a deceleration command is obtained (“Yes” in the operation S1710), the stability controller 130 may perform deceleration control and motor torque compensation control in the third section in an operation S1720.

In an operation S1730, the stability controller 130 may perform coasting control in the third section, regardless of whether or not the deceleration command is obtained.

In an embodiment, although the aforementioned control process has been described based on the situation where the vehicle 10 and the object 20 cross each other in the opposite directions, it may be similarly applied to a case where the object 20 overtakes the vehicle 10 as follows.

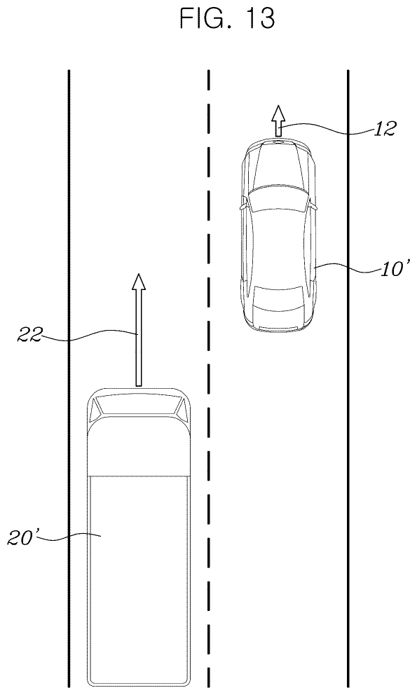

FIG. 13 is a drawing illustrating a situation in which an object overtakes a vehicle according to an embodiment of the present disclosure.

FIG. 13 shows the situation in which, while a vehicle 10′ is driving in the forward direction 12, an object 20′ is travelling on the left side of the vehicle 10 from behind in a direction 22 parallel to the travelling direction of the vehicle 10′ and is attempting to overtake the vehicle 10′. Even if the object 20′ overtaking from behind is detected, the stability controller 130 may control the vehicle 10′ similarly to the case in which the object crosses the vehicle in the opposite direction. For example, the stability controller 130 may determine a preset time based on the relative position of the object 20′ and may perform braking or coasting control corresponding to each time.

In the conventional technology, the vehicle 10 may experience longitudinal and lateral instability due to crossing or overtaking of the vehicle 10 and the object 20.

The vehicle 10 to which an embodiment of the present disclosure is applied may predetermine a time at which the crosswind occurs due to crossing and a change in stability of the vehicle 10 due to the crosswind and may perform operations such as lopsided braking or coasting control corresponding to each time according thereto, thereby preventing the vehicle 10 from experiencing lateral instability.

In addition, the acceleration of the vehicle 10 may be restricted for a preset period of time after the end of crossing, thereby preventing accidents due to restricted visibility when crossing or overtaking another vehicle and securing the stability of the vehicle 10.

The present disclosure as described above may be implemented as codes in a computer-readable medium in which a program is recorded. The computer-readable medium includes all types of recording devices in which data readable by a computer system are stored. Examples of the computer-readable medium include a hard disk drive (HDD), a solid state disk (SSD), a silicon disk drive (SDD), a ROM, a RAM, a CD-ROM, a magnetic tape, a floppy disk, an optical data storage device, and the like. The above detailed description should not be construed in a limitative sense, but should be considered in an illustrative sense in all aspects. The scope of the present disclosure should be determined by reasonable interpretation of the appended claims, and all changes and modifications within the equivalent scope of the present disclosure fall within the scope of the present disclosure.

What is claimed is:

1. A method of controlling a vehicle, the method comprising:
detecting an object satisfying preset object conditions and driving conditions for approaching the vehicle;
determining i) a first control time based on the driving conditions and ii) a second control time after the first control time;
performing first vehicle stability control at the first control time; and
performing second vehicle stability control in an opposite yaw-rate control direction to the first vehicle stability control at the second control time.

2. The method of claim 1, wherein:
the first control time is determined to be a first time at which lateral crossing of the vehicle begins, and
the second control time is determined to be a second time at which the lateral crossing of the vehicle ends.

3. The method of claim 2, wherein performing the first vehicle stability control comprises performing lopsided braking control on a wheel of the vehicle that is provided on a side facing the object in a lateral direction of the vehicle.

4. The method of claim 2, wherein performing the second vehicle stability control comprises performing lopsided braking control on a wheel of the vehicle that is provided on a side opposite the object in a lateral direction of the vehicle.

5. The method of claim 3, wherein performing the first vehicle stability control comprises outputting a compensation torque corresponding to lopsided braking torque of the first vehicle stability control to control a driving torque of the vehicle.

6. The method of claim 1, further comprising controlling a longitudinal acceleration of the vehicle in at least one of the first vehicle stability control or the second vehicle stability control.

7. The method of claim 6, wherein:
the first vehicle stability control comprises control to reduce the longitudinal acceleration of the vehicle; and
the second vehicle stability control comprises control to increase the longitudinal acceleration of the vehicle.

8. The method of claim 6, wherein controlling the longitudinal acceleration of the vehicle comprises controlling the longitudinal acceleration of the vehicle through coasting torque control of the vehicle.

9. The method of claim 1, wherein:
the driving conditions are determined based on at least one of relative distance between the object and the vehicle or image information of the object; and
the object conditions are determined based on at least one of a size of the object or a relative speed between the object and the vehicle.

10. The method of claim 3, wherein performing the first vehicle stability control comprises performing the lopsided braking control based on a yaw rate, wherein the yaw rate is determined based on a preset model using at least one of a size of the object, a speed of the vehicle, a relative speed between the object and the vehicle, or a relative distance between the object and the vehicle.

11. A vehicle comprising:
a sensor unit configured to detect an object that satisfies preset object conditions and driving conditions for approaching the vehicle; and
a controller configured to
determine i) a first control time based on the driving conditions and ii) a second control time after the first control time,
perform first vehicle stability control at the first control time, and
perform second vehicle stability control in an opposite yaw-rate control direction to the first vehicle stability control at the second control time.

12. The vehicle of claim 11, wherein:
the first control time is determined to be a first time at which lateral crossing of the vehicle begins; and
the second control time is determined to be a second time at which the lateral crossing of the vehicle ends.

13. The vehicle of claim 12 wherein the controller is configured to, at the first time, perform lopsided braking control on a wheel of the vehicle that is provided on a side facing the object in a lateral direction of the vehicle.

14. The vehicle of claim 12 wherein the controller is configured to, at the second time, perform lopsided braking control on a wheel of the vehicle that is provided on a side opposite the object in a lateral direction of the vehicle.

15. The vehicle of claim 13, wherein the controller is configured to output a compensation torque corresponding to lopsided braking torque of the first vehicle stability control to control a driving torque of the vehicle.

16. The vehicle of claim 11, wherein the controller is further configured to control a longitudinal acceleration of the vehicle in at least one of the first vehicle stability control or the second vehicle stability control.

17. The vehicle of claim 16, wherein:
the first vehicle stability control comprises control to reduce the longitudinal acceleration of the vehicle; and
the second vehicle stability control comprises control to increase the longitudinal acceleration of the vehicle.

18. The vehicle of claim 16, wherein the controller is configured to control the longitudinal acceleration of the vehicle through coasting torque control of the vehicle.

19. The vehicle of claim 11, wherein:
the driving conditions are determined based on at least one of a relative distance between the object and the vehicle or image information of the object; and
the object conditions are determined based on at least one of a size of the object or a relative speed between the object and the vehicle.

20. The vehicle of claim 13, wherein the controller is configured to perform the first vehicle stability control based on a yaw rate, wherein the yaw rate is determined based on a preset model using at least one of a size of the object, a speed of the vehicle, a relative speed between the object and the vehicle, or a relative distance between the object and the vehicle.
